(19) United States
(12) Patent Application Publication
(10) Pub. No.: US 2003/0191784 A1
(43) Pub. Date: Oct. 9, 2003

(54) Distributed database management method

(76) Inventor: Michel Buri, Cheseaux-sur-Lausanne (CH)

Correspondence Address: Supervisor Patent Prosecution Services, Piper Rudnick, 1200 Nineteenth Street NW, Washington, DC, 20036-2412, US

(21) Appl. No.: 10/276,613

(22) PCT Filed: May 17, 2001
(86) PCT No.: PCT/IB01/00868

(30) Foreign Application Priority Data
May 18, 2000 (CH) 0995/00

(51) Int. Cl. G06F 17/30

(52) U.S. Cl. 707/206

(57) ABSTRACT

The possibilities that are offered to the subscribers of pay television are more and more varied and follow the expectations of consumers. In order to go towards a personalisation of the products proposed to the subscribers it is important to be able to determine the criteria that condition a particular offer using not only the subscriber parameters but also the parameters that can start several subscribers.

The method according to the invention consists in memorising in a distributed data base operating centre the group of images of the data bases and carrying out operations tending to fulfil a condition on the group of images of the data bases.

In this way, if the condition returns a satisfactory result, the command will be sent to the group of considered data bases.

The present invention concerns the management and the updating of distributed data bases, particularly for the management of a network of pay television decoders as well as allowing access to these data bases.

In a system that comprises an operating centre and a plurality of subscribers distributed throughout a vast territory, each consisting of a subscriber data base, it is known to send management and updating information of the data bases of these subscribers by Hertzian route, by satellite, or by cable. These messages are sent to either all the subscribers, to a particular subscriber, or to a group of subscribers.

The operating centre contains an interpreter that allows to establish the link between the logical address of a subscriber and his/her physical address, allowing thus the link with the group of information distributed in the data bases of the subscribers. In this way a request from a system upstream of the centre, such as the subscriber management system, can access the content of any subscriber data base without it being necessary to know his/her physical address.

According to the embodiment, transmission can be carried out in the reverse direction, that is, the subscriber management system can question one of the subscriber data bases by means of the interface that represents the operating centre. However, this operation is only possible when there exists a return channel between the subscriber module and the operating centre.

When one or several of the data bases have to be updated, the centre receives the information to be processed and determines the physical address of the data bases of the subscribers to be able to establish a link with them by means of satellite connection, cable or Hertzian route.

The content of these subscriber data bases reflects the various subscriptions and services which the subscriber can access. The services offered by the distributors have greatly evolved during recent years and the times when only one subscription to one or another chain was proposed, have been revolutionised.

The offer that is desired is dynamic, evolutional, and that satisfies the needs of the client.

For this, new needs have appeared that tend to individualise the services offered to the clients, that is, that propose services depending on criteria such as previous consumption, geographic location, being member of a group (family, bachelor, student, etc.). This concept is easily applicable when all the elements that allow to determine the client's profile are accessible in a single base, but it is more difficult when the information is distributed in a great number of data bases.

Furthermore, because certain systems of this type do not use return channels to the operating centre, it is difficult for the latter to know if the sent information arrives correctly. Because of this, it is obligatory to repeat these messages periodically in order to ensure that the message reaches its destination at least once.

It can easily be imagined what this produces in a system that uses a great number of subscribers, for example 2 to 3 million: the repetition of these messages can rapidly saturate the transmission capacities.

In a pay television system the transmission channel is mostly used to transmit numeric data, and the management information in the subscriber data bases can only occupy a very limited space.

The objective of the present invention is to allow the establishment to transmit the information in the most condensed form to the distributed data bases.

This objective is achieved by an operating centre of distributed data bases consisting of a main data base in which can be found the group of distributed data bases. This operating centre can not only carry out operations according to the content of an image of data bases but can also carry out operations resulting from the data distributed on several data bases. The main data base also contains information about the subscriber, information which is not necessarily stored in the subscriber data base.

By operation is understood a transmission to a data base or a group of data bases in order to modify their content.

In this way, by means of this structure it is possible to determine the data bases concerned by the service offered by the subscriber management system.

This determination can be made by comparing several data bases, for example when it is wished to attribute services according to a system of points that are collected on a group of users.

According to this example, a group is defined that can represent an institution such as a hospital that has a great number of subscriber modules and thus of data bases. In this case, a free of charge service will be offered to the members of this group on the basis, not of data from a single base, but on the basis of the result of a processing a group of data bases.

The solutions according to the state of the art do not allow to carry out operations whose parameters are dispersed in several data bases.

The known subscriber management systems can only address one or several distributed data bases through an operating centre according to the addressing criteria defined by the system itself. These criteria are single, addressing a group, or all of the data bases.

The invention will be better understood by means of the following detailed description which makes reference to the annexed drawings that are offered as a non-limiting example, in which:

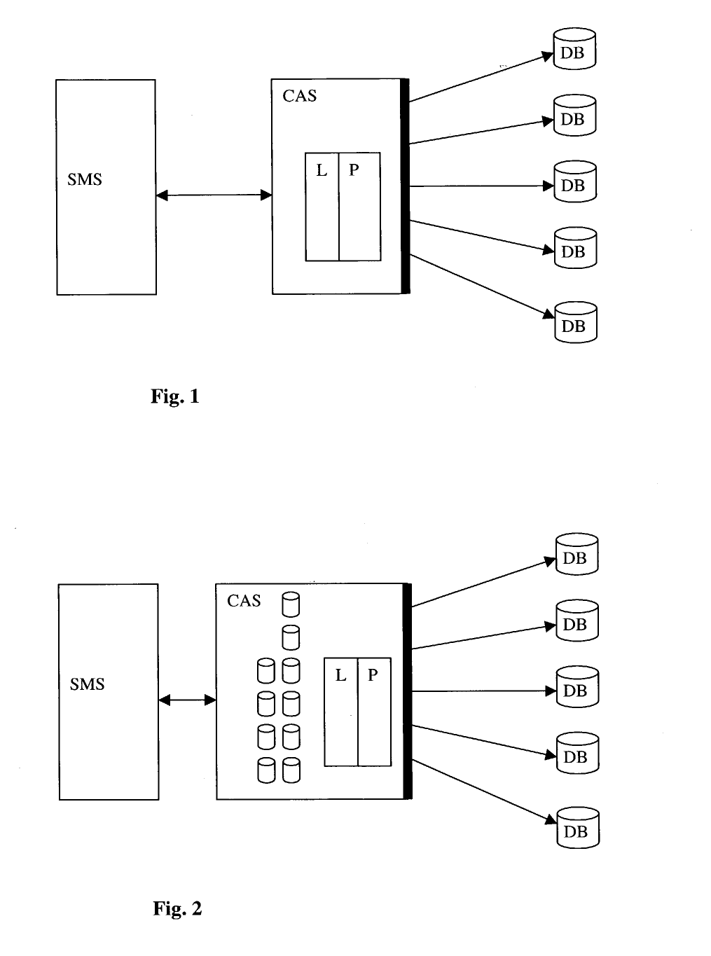

FIG. 1 represents an operating centre according to the state of the art;

FIG. 2 represents an operating centre according to the invention.

In FIG. 1, representing the state of the art, the SMS system (Subscriber Management System) communicates with the CAS operating centre (Conditional Access System) in order to access one or another of the distributed data bases (DB). The CAS centre serves as an addressing converter between a high level for the SMS and a low level for the DB data bases.

In this way, according to this technique, the CAS serves essentially to create a logical representation of the different data bases of the subscribers and to allow an access that is independent of the material implementation. This function of logical/physical converter is of the CAS.

One of the other important tasks of the CAS is to support the communication protocol with the data bases.

In FIG. 2, the CAS according to the invention contains an image of each of the data bases it is in contact with. The requests of the SMS are firstly processed by the CAS, which determines the data bases that are concerned. The CAS according to the invention is capable of carrying out logical operations on the image of the distributed data bases in order to satisfy the conditions defined by the SMS.

In this way, according to one embodiment of the invention, the SMS system requires the blockage of the transmission decoding for a given region. This is used for example during the celebration of a sports competition in this region in order to convince spectators not to watch the event on television but to go there and see it live.

In this case, the SMS transmits a blockage request (blackout) specifying the geographic zone and the duration. The zone information can either consist of a list of zip codes, an interval of zip codes (start-end) or the designation of a region such as a department, a county, or a state.

The CAS determines the group of subscriber, data bases concerned by this request and transmits this information to the subscriber data bases according to the protocol supported by the management module of the subscriber data bases.

In fact, the supported protocol can be of different nature according to the generation of the management modules of the subscriber data bases. The first generation protocol only recognises two types of addressing, either the single addressing that has one DB base or without address, that is aimed to the group of DB bases.

An embodiment has been introduced which includes the address according to the zip code or according to an interval of zip codes.

If other criteria are defined by the SMS, the CAS has only to address individually each DB personally.

Recent developments in terms of protocol supported by the DB bases comprise elaborated functions by which the updating of the data bases is conditioned by the parameters contained in said base. In this way, according to the type of protocol the conditions for defining a group of users are directly transmitted to the bases who will determine themselves if they satisfy this condition.

The CAS according to the invention offers the SMS this type of command that allows to offer personalised services. It is thus possible for the SMS to offer all the subscribers of a chain A for more than a year the availability of a new chain or B for a duration of a month. The CAS determines the data bases concerned with using the images of these bases contained in the main data base and transmits this condition to the subscriber modules.

These subscriber modules carry out the conditional operation and according to the result (chain A for more than a year) they update their data base in order to include the decoding rights of the chain B.

Another aspect of the CAS according to the invention is the determination of a criterion that depends on several data bases. The preceding example concerns the processing of a single subscriber data base according to one or several criteria.

According to one embodiment of pay television it is possible to purchase services à la carte. The subscriber has a credit in his/her data base which he/she can use to view, against payment, an emission of his/her choice.

When a group of subscriber modules is considered, it could be desirable to offer them particular services, determined according to the global consumption of the group. It is then necessary to accumulate the purchases of each member of the group to obtain the condition defined for the obtention for example of the free of charge service.

The CAS according to the invention has means to carry out the starting operations on an image group of data bases in order to determine the desired criterion. If the condition is fulfilled, a transmission will be initiated containing the designation of the considered group and the offered service.

If, on the contrary, the condition is not fulfilled, the CAS will return the corresponding information to the SMS.

1. A method for managing and updating of a group of distributed data bases (DB) linked at least with an operating centre (CAS), comprising the following steps:
memorising of the image of said data bases (DB) in a main data base located in the operating centre (CAS),
receiving by the operating centre of a conditional command for updating one or several data bases,
determining the data bases that satisfy the condition by means of the images of said data bases, and
if at least one data base is concerned, transmitting the command to the data bases according to the protocol supported by them.

2. A method according to claim 1, characterised in that this determination is carried out by combining the information contained in the images of the data bases.

3. An operating centre of a group of distributed data bases (DB) comprising an interface towards a subscriber management system (SMS), an interface towards the data bases (DB), and a conversion unit between the physical address and the logical address of the data bases, characterised in that the centre (CAS) comprises a main data base comprising the image of the data bases (DB).

4. An operating centre according to claim 3, characterised in that it comprises means for receiving commands of conditional updating by the interface of the subscriber management system, means for determining which data bases satisfy the condition by means of the images of said data bases, and means for transmitting the command to the data bases according to the protocol supported by them.
